(19) United States
(12) Patent Application Publication
(10) Pub. No.: US 2005/0114165 A1
(43) Pub. Date: May 26, 2005

(54) System for verifying matched suitability between a gliding or rolling device and gear to be worn by the user

(75) Inventors: Frederic Allegre, Sillingy (FR); Roger Jaccoud, Rumilly (FR)

Correspondence Address: GREENBLUM & BERNSTEIN, P.L.C., 1950 ROLAND CLARKE PLACE, RESTON, VA, 20191, US

(73) Assignee: SALOMON S.A., Metz-Tessy (FR)

(21) Appl. No.: 10/956,147

(22) Filed: Oct. 4, 2004

Related U.S. Application Data
(63) Continuation of application No. PCT/FR03/01083, filed on Apr. 4, 2003.

(30) Foreign Application Priority Data
Apr. 5, 2002 (FR) 02.04484

(51) Int. Cl. G06F 17/60

(52) U.S. Cl. 705/1

(57) ABSTRACT

A processing system and method designed to verify a compatibility between a gliding or rolling device, such as a ski or a snowboard, and an item of gear, such as a boot, that can be associated with the device, from among a plurality of devices and items of gear. The device and gear include one or more elements which include, for each such element, an identification label bearing a remotely readable identification code particular to each such element. The label reader is connected to a computer processing unit that includes a computer program for processing identification codes of the device and gear read by the reader and for delivering information representing the compatibility, or degree of compatibility, between the device and the gear.

### CROSS-REFERENCE TO RELATED APPLICATION

This application is a continuation of International Patent Application No. PCT/FR03/01083, having an international filing date of Apr. 4, 2003, the disclosure of which is hereby incorporated by reference thereto in its entirety, and the priority of which is hereby claimed under 35 U.S.C. §120.

This application is based upon French Patent Application No. 02.04484, filed Apr. 5, 2002, the disclosure of which is hereby incorporated by reference thereto in its entirety and the priority of which is hereby claimed under 35 U.S.C. §119.

### BACKGROUND OF THE INVENTION

1. Field of the Invention

The invention relates to a method of verifying the suitability of a gliding and rolling device, such as a ski or snowboard, and various items of gear to be carried by the user of the device. The invention also relates to a system used in the method of such verification.

2. Description of Background and Relevant Information

Many sporting activities which utilize a gliding or rolling device require a user to carry particular designated gear/equipment designed as a function of such device, such as shoes/boots, or protective equipment, such as a helmet or protective pads or linings. Ocassionally, a person engages in a plurality of different activities requiring different gear on a same type of terrain.

For example, on snow it is possible to practice the sports of ski touring, alpine skiing, cross-country skiing, telemark skiing, snowboarding, snow shoeing, and still other sporting activities or disciplines.

During a stay at a sports park, for example, visitors increasingly engage themselves in several different sporting activities. As a result, the owners of such parks find it necessary to offer in their rental shops various gliding and rolling devices, such as skis, snowboards, skateboards, or other devices for practicing the any of the aforementioned activities, as well as the equipment/gear that are associated with such devices.

For example, alpine skis are intended to be used with releasable bindings whose correct operation is conditioned upon the use of alpine ski boots which comply with a “junior” or “senior” standard.

At present the verification of this compatibility between the device and its associated equipment/gear is left as a responsibility of the retailer, such as a park operator, or to the user. Taking into account the number and variety of products there is a risk of confusion in the compatibility between the device and its associated equipment/gear.

The problem is the same for a pair of skates and the associated gear, such as a helmet and/or protective pads. Indeed, a helmet is designed to be used during the practice of particular predetermined sports; a helmet for skiing or climbing, for example, might not be well-adapted for use in the practice of in-line skating.

### SUMMARY OF THE INVENTION

An object of the invention is to propose a processing system for facilitating the verification by a retailer/operator or a user in controlling the correct matching, or compatibility, between a gliding or rolling device and its associated gear/equipment.

Another object of the invention is to propose a processing system that advantageously supplements an existing processing system for the management of a rental shop or sports park.

Other objects and advantages of the invention will become apparent from an understanding of the description which follows.

The processing method according to the invention is provided to verify the compatibility, i.e., the matching suitability, between a gliding or rolling device and associated gear/equipment (hereafter “gear” or “equipment”) among a plurality of possible combinations of devices and gear, the device and gear comprising one or more elements. It comprises, for each device and for each item of equipment, an identification support/substrate bearing an identification code specific to the device or the item of equipment and which is remotely readable, and at least one reader designed to read the aforementioned codes. The invention provides for the processing of identification codes of the device and equipment read by the reader being connected to an computer processing unit, a computer program of the identifying codes of the device and gear that are read by the reader, and the display of information representing the compatibility between the device and the equipment.

The processing system according to the invention is provided to verify the compatibility between a gliding or rolling device and associated equipment among a plurality of models of devices and items of equipment, each of the device and items of equipment comprising one or more elements.

For each device and item of equipment, the invention comprises an identification tag or label bearing an identifying code specific to the device or the item of equipment and being remotely readable, at least one reader designed to read the code, the reader being connected to an computer processing processing unit which includes a computer program to process the identification codes of the device and equipment read by the reader, and to deliver information representing the compatibility between the device and the equipment.

The description below relates to the application of the invention to a pair of skis and boots. However, the description is intended only to be illustrative of the invention and is provided for the purpose of assistance in providing an understanding of the invention. The description of this one particular application, therefore, is not intended to be restrictive.

### BRIEF DESCRIPTION OF DRAWINGS

The invention will be better understood and other advantages thereof will become apparent from the description that follows, with reference to the annexed drawings, whereby the description illustrates, by way of non-limiting examples, certain preferred embodiments. The drawings include the following views:

FIG. 1 is a general view of a pair of skis;

FIG. 2 is a view of a pair of ski boots, seen from the rear;

FIG. 3 is a schematic representation of equipment useful in the implementation of the invention; and

FIG. 4 is a schematic representation of a block diagram of a central processing unit.

### DETAILED DESCRIPTION OF THE INVENTION

The following description relates to an application of the invention to a pair of skis and boots. It is to be understood, however, that such application is only intended to illustrate the invention, and that it is not limiting.

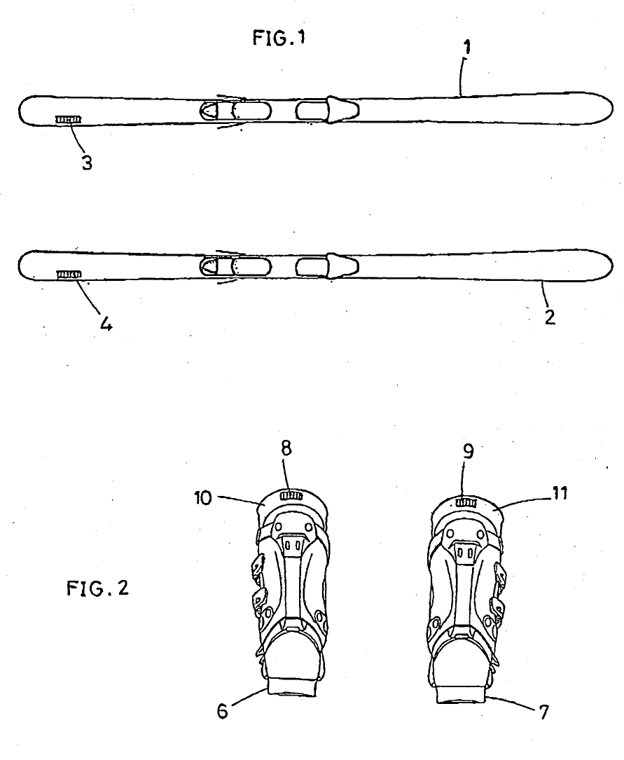

FIG. 1 shows a top view of skis 1 and 2, which pair of skis are intended for the practice of the alpine skiing. The two skis form a gliding device in the context of the invention. They can be considered to have any suitable structure.

Each ski has a support 3 or 4, respectively, such as a tag, label, or substrate, which bears an identification code of the ski in involved.

In the present case, the support is a label which is positioned beneath the upper decoration layer of the ski. For example, the label is placed at the rear of the ski, on the top, and it is visible by transparency through the decoration layer. An identification code is printed, or otherwise secured, onto the label. For example, the code is formed by a series of lines to form a code of the barcode type for each ski, the code being readable by a reader, such as a portable barcode reader or a barcode reader which is part of a station, the barcode of each ski is transparently readable through the decoration layer.

According to one form of the invention, the identification code is specific to the ski, i.e., the two skis have different codes.

This mode of identification of the skis is not restrictive, and other supports or tags can be appropriate. For example, one could adopt a data exchange label as disclosed in the patent publication FR 2 812 209 and in U.S. Pat. No. 6,618,632, such as that shown in FIGS. 3 to 5 thereof. For this purpose, the disclosure of U.S. Pat. No. 6,688,632 is hereby incorporated by reference thereto in its entirety. The label would then be integrated into the structure of the ski and it would be readable remotely by a reader having a magnetic field. The identification code of the ski is, in this case, stored in a read-only memory zone of the active element of the label.

According to another possibility, the support or tag is a self-adhesive label or the like attached to the upper surface of the ski by the retailer or park operator. The label carries a code such as a barcode or any other appropriate code.

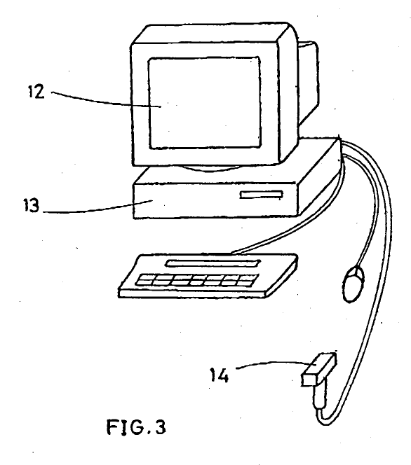

FIG. 2 illustrates, from the rear, two ski boots 6 and 7 which form a pair of boots. These boots constitute gear or equipment within the context of the invention.

Each of the two boots has a respective support 8, 9 which bears an identification code. In this case, the support is a label which is positioned, such as being sewn, on the upper part of the back of the liner 10, 11. Each label is visible above the shell of its respective boot. A remotely readable code, of the barcode type, for example, is printed or engraved on the label. According to one example of the invention, each boot has a specific code.

As in the case of the skis, alternatively, one could use as a support a data exchange label which would be integrated into the structure of the boot, or a label applied to the rear.

The identification codes of the skis and the boots are preferably of the same type, so that they can be read by the same reader, but one could also have codes of different types with appropriately adapted readers.

FIG. 3 diagrammatically shows computing equipment for implementing the invention.

This equipment includes a computer with a screen 12 and one central unit 13, and a reader 14 adapted to read the codes of the skis and boots. This equipment is not restrictive, and, in addition, it can include any of various conventional peripherals such as a keyboard, a mouse, a printer, and/or other such peripherals. Similarly, instead of a pistol-type reader, one could use any other particularly adapted device, such as a stationary reading station.

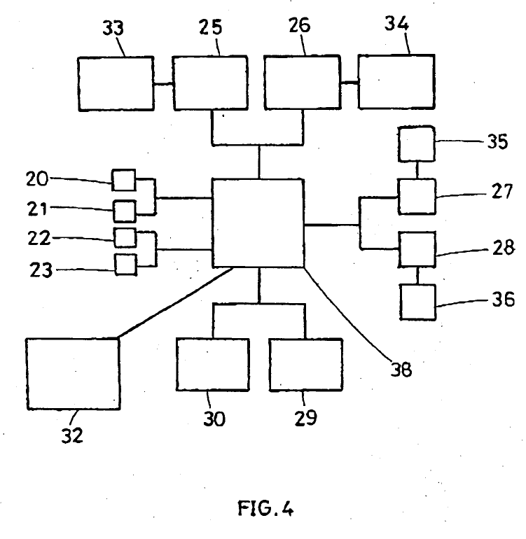

FIG. 4 shows a block diagram of a central unit.

A first block is formed by temporary memory zones 20, 21, 22, 23 where the identification codes of the device and gear are stored temporarily after they have been read by the reader 14. According to the illustrated embodiment, there is a memory zone for each component of the device and the gear, i.e., four zones in this case, so that the codes can be processed individually.

Furthermore, the central unit contains in memory identification tables 25 and 26, with information relating to the identification of the elements of the device and of the gear, respectively.

For a rental shop or sports park, for example, the identification tables contain all of the identification codes of the skis and of the boots, and at least all those which are managed by the system.

According to the invention, the central unit also can contain in memory relational tables 27, 28 indicative of the relationships between the identification codes of the skis and of the boots with various models, and possibly the various production years of the models involved. In other words, these tables identify the model of ski or boot from their respective identification codes.

These tables can be created in various ways. For example, the tables can be created by manual data entry, or by the reading of a label carrying a barcode indicative of the model that the ski or the boot carries when it is delivered.

These tables can also be created by transfer from a data processing device such as a floppy disk or a CD-ROM which would be provided by the manufacturer of the equipment in question.

One could also create these tables by downloading from the Internet.

Preferably, parity tables 29, 30 are in addition provided in the memory of the central unit to verify that the identification codes which were entered for the various elements of the device or for the gear are indeed those of the same device or of the same gear. In other words, for a pair of skis or boots, these tables associate the identification codes of the two components of the pair.

A table of compatibility 32 is located in the memory of the central unit. This table indexes all the models of the gliding devices and equipment, and indicates the degree of compatibility which exists between them.

The degree of compatibility can be a simplified all-or-nothing type of degree, i.e., “compatible” if the device and the gear are an adequate match, or “not-compatible” for the contrary case. It can be also complex, i.e., indicate an adequacy subject to additional verification parameters, for example parameters of weight or size of the future user. In this case, one can add reserve tables 33, 34, 35, 36 to the identification tables and/or to the relational tables. These tables contain the reserve parameters associated with the use of the various models of the device and gear.

For the reserve tables 33 and 34 relating to the skis, one can possibly include reserve parameters relating to the binding elements with which the skis are equipped. For example, these parameters can be such that the skis with their bindings can be used only with a boot of an appropriate “junior” or “senior” standard-compliant.

The number of the memory zones and tables is not restrictive. The memory zones and the tables could be combined. The purpose of the disclosure which has been just presented is only to facilitate an understanding of the invention.

A computer processing unit 38 is in relation to these various memory zones and tables.

The unit is loaded with instructions carrying out the functions which consist of reading the identification codes of the various components of the device and of the gear by means of the reader 14, to temporarily store the codes in the memory zones 20, 21, 22, 23, to identify these elements using the identification tables 25, 26, to associate the product models using tables 27, 28, to verify the association of the components of a pair using tables 30, 31, to deliver compatibility information using table 32, accompanied, if necessary, by the usage reserves generated from the tables 33, 34, 35, 36.

These functions are not stated in a restrictive way and other alternatives are possible.

For example the compatibility of the products could be determined directly from their identification. Also, the verification of the components of the pair is optional, and the verification of compatibility could be performed on the basis of only one component of a pair.

The information output by the computer central processing unit 38 is transmitted to the retailer or park operator by any appropriate visual, auditive, or different means. For example, the information can be delivered on the screen 12, printed on a card relating to the rental of the equipment, or by means of a sound signal indicating a positive or negative compatibility.

Thus, for example, in the case of a rental shop having two different types of boots, such as conventional standardized boots and specialized boots such as ones designed to facilitate walking while not associated with their respective gliding devices, the system makes it possible to control that the various components of the equipment are indeed compatible, in particular that the boots provided for facilitating walking are used with skis equipped with appropriate/adequate binding elements. In this regard, for example, U.S. Pat. No. 6,779,809 discloses a binding adapted for a boot that can be used for skiing as well as walking, the disclosure of which is hereby incorporated herein in its entirety.

The invention is not limited to particular embodiment which has been just described, and one could adopt other implementations of the invention without leaving the scope of the invention.

In particular, the present system could be associated with other systems for managing an equipment shop, for example, relative to the use of the equipment, its maintenance, with the release adjustment of the bindings elements depending upon to the user, etc.

Moreover, as described above, the system is not limited to a rental shop for alpine ski equipment; it can also be applied generally to various alpine sporting activities, such as snowboarding, telemark skiing, cross country skiing, etc.

In this case, the system would make it possible, for example, to signal a mismatch between alpine skis and boots intended for the practice of snowboarding or telemark skiing.

Finally the foregoing description was given for equipment having two components of the same type for the device and the equipment. This is not limiting, and the processing system of the invention could in the same way control the compatibility of more than two sets of components. For the device of the preceding example, there could be more than two components, and the system could distinctly process the skis and the binding elements. Similarly, for the equipment/gear, the system could process, in addition to the boots, a component such as an individual protection gear, for example, a helmet, gloves, knee pads, elbow pads, or the like.

In this case in addition to the verification of the compatibility between the various components of the equipment, one can also provide that the computer processing system carry out the function of verifying the presence of all the components necessary for the sports activity involved, and particularly the presence of these individual protection elements.

1. A method for verifying compatibility between a gliding or rolling device and gear from among a plurality of models of devices and gear, each device and gear comprising one or more elements having an identification tag bearing a remotely readable identification code specific to each respective element of the devices and gear, at least one reader for reading said identification codes, said method comprising:
reading the identification codes of an element of at least one said device and an element of at least one said gear with a reader and transmitting information relating to the identification codes so read to a computer;
processing said information with a computer program; and
displaying information representing a compatibility status of the element of said device and the element of said gear.

2. A method according to claim 1, wherein:
at least one table is used for identifying at least one component of said device and said gear.

3. A method according to claim 1, wherein:
at least one relational table is used between the identification code of the device or of the gear and the model of the device or the gear.

4. A method according to claim 1, wherein:
at least one compatibility table is used for verifying compatibility a model of the device and a model of the gear.

5. A system for verifying compatibility between a gliding or rolling device and gear from among a plurality of models of devices and gear, each device and gear comprising one or more elements having an identification tag bearing a remotely readable identification code specific to each respective element of the devices and gears said system comprising:
at least one reader for reading said identification codes;
a computer processing unit connected to said at least one reader;
a computer program for processing information received from said reader relating to said identification codes so read;
transmitting information to be sensed relating to a compatibility status of the element of said device and the element of said gear.

6. A system according to claim 5, further comprising:
at least one temporary memory zone for storing identification codes read by the reader.

7. A system according to claim 5, further comprising:
at least one table for identifying at least one component of said device and said gear.

8. A system according to claim 5, further comprising:
at least one relational table including relational information between the identification code of said device or gear and a model of said device or gear.

9. A system according to claim 5, further comprising:
at least one compatibility table including compatibility information between a model of the device and a model of the gear.

10. A system according to claim 5, whereby the device or the gear comprise several components, further comprising:
at least one parity table including parity information between the components of the device or of the gear.

11. A system according to claim 7, further comprising:
at least one reserve table associated with an identification table or a relational table.

12. A system according to claim 6, wherein:
the computer processing unit comprises means for identifying components of the device and the gear by means of identification codes or at least one identification table.

13. A system according to claim 7, wherein:
the computer processing unit comprises means for identifying models of the device and the gear by means of identification and relational tables.

14. A system according to claim 8, wherein:
the computer processing unit comprises means for transmitting information regarding the compatibility status of the elements of the device and the gear by means of a compatibility table.

15. A system according to claim 11, wherein:
the computer processing unit comprises means for transmitting information regarding usage reserves by means of reserve tables.

16. A system according to claim 10, wherein:
the computer processing unit comprises means for verifying that multiple elements of the device or of the gear correspond to the same device or gear, respectively.

17. A system according to claim 5, wherein:
the computer processing unit comprises means for verifying presence of all elements of the device and of the gear that are required for using the device.
